(19) United States
(12) Patent Application Publication
(10) Pub. No.: US 2016/0311258 A1
(43) Pub. Date: Oct. 27, 2016

(54) TIRE INCLUDING A TREAD BASED ON A RUBBER COMPOSITION COMPRISING EX-PITCH CARBON FIBERS

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Vincent ABAD, Clermont-Ferrand (FR); Guillaume HENNEBERT, Clermont-Ferrand (FR)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/103,766

(22) PCT Filed: Dec. 5, 2014
(86) PCT No.: PCT/EP2014/076696

§ 371 Date: Jun. 10, 2016

(30) Foreign Application Priority Data
Dec. 10, 2013 (FR) 1362331

(51) Int. Cl. B60C 1/00; B29D 30/08; C08K 13/04

(52) U.S. Cl. CPC B60C 1/0016; C08K 13/04; B29D 30/08; B29K 2021/00

(57) ABSTRACT

The present disclosure relates to a tire including a tread that has a rubber composition based on at least an elastomer matrix, a reinforcing filler, ex-pitch carbon fibres, z being the direction normal to the surface of the tread intended to be in contact with a running surface, x and y being two directions orthogonal to z, x the circumferential direction of the tire, y the axial direction with respect to the axis of rotation of the tire, Cx, Cy and Cz being the thermal diffusivities measured at 25° C. of the tread in the cured state respectively in the directions x, y and z, which tire has Cz/Cx and Cz/Cy thermal diffusivity ratios of greater than 2. Such a tire has an improved compromise between the productivity of the curing step in the manufacture of the tire and the wear performance of the tire.

### CROSS-REFERENCE TO RELATED APPLICATIONS

This application is a 371 national phase entry of PCT/EP2014/076696, filed 5 Dec. 2014, which claims the benefit of French Patent Application No. 1362331, filed 10 Dec. 2013, the contents of which are incorporated herein by reference for all purposes.

### BACKGROUND

One particularly desired performance of tires is the wear. The tread that is in actual contact with the running surface is the part of the tire that is essentially subjected to the wear phenomenon. In order to improve the wear resistance of treads, use is typically made of materials based on rubber reinforced by relatively fine fillers. These relatively fine reinforcing fillers are most often small-sized objects, i.e. submicron-sized objects. Conversely, the use of coarser objects of the order of a micron generally has the effect of reducing the wear resistance of the tread.

The manufacture of a tire requires a step of curing the tire which makes it possible to crosslink, in particular vulcanize, the rubbery components of the tire. This curing step is a determining factor for the tire performances. Specifically, the degree of crosslinking will determine the properties of the rubbery components. In order to seek gains in productivity in the manufacture of the tires, it is beneficial to be able to reduce the time of this curing step without affecting the desired degree of crosslinking of the rubbery components of the tire. One solution to this problem is to make certain rubbery components of the tire thermally conductive, for example by introducing thermally conductive objects into the compositions of the rubbery components of the tire. Among the thermally conductive objects, mention may for example be made of carbon nanotubes, silicon carbide fibres and carbon fibres. However carbon fibres have the drawback of being coarse objects, in particular of the order of a micron. Consequently, the use thereof in a rubber composition for a tread most often results in the wear resistance of the tread being very greatly reduced.

### SUMMARY

The applicant companies have discovered that the use of specific carbon fibres orientated in a specific manner in a tread of a tire makes it possible to offer an improved compromise between the thermal conductivity and the wear resistance of the tread, moreover without being significantly detrimental to the other performances such as for example the grip of the tire.

Thus, a first subject of the disclosure is a tire comprising a tread that comprises a rubber composition based on at least:
an elastomer matrix,
a reinforcing filler,
ex-pitch carbon fibres,
optionally a plasticizer,
z being the direction normal to the surface of the tread intended to be in contact with a running surface, x and y being two directions orthogonal to z, x the circumferential direction of the tire, y the axial direction with respect to the axis of rotation of the tire,
Cx, Cy and Cz being the thermal diffusivities measured at 25° C. of the tread in the cured state respectively in the directions x, y and z,
which tire has Cz/Cx and Cz/Cy thermal diffusivity ratios of greater than 2.

Another subject of the disclosure is a process for manufacturing the tire in accordance with the disclosure.

Another subject of the disclosure is a layer consisting of the same rubber composition as the tread of the tire in accordance with the disclosure, which layer has C′z′/C′x′ and C′z′/Cy′ thermal diffusivity ratios of greater than 2,
C′x, C′y′ and C′z′ being the thermal diffusivities measured at 25° C. of the layer in the cured state respectively in the directions x′, y′ and z′,
x′, y′ and z′ being directions orthogonal to one another, z′ being the preferential direction of the carbon fibres.

Another subject of the disclosure is a process for manufacturing the layer in accordance with the disclosure.

Another subject of the disclosure is a tread or a tread portion of a tire, which tread or tread portion is formed by the juxtaposition of layers in accordance with the disclosure assembled along their faces perpendicular to the direction x′, x′ being the direction orthogonal to the midplane of each layer (y′z′) defined by the directions y′ and z′, the direction z′ coinciding with the radial direction of the tire.

### BRIEF DESCRIPTION OF THE DRAWINGS

FIG. 1 illustrates an example of the tire according to an exemplary embodiment disclosed herein.

### DETAILED DESCRIPTION

In the present description, unless expressly indicated otherwise, all the percentages (%) indicated are % by weight. The abbreviation “phr” means parts by weight per hundred parts of the elastomer matrix of the rubber composition, the elastomer matrix consisting of all of the elastomers present in the rubber composition.

Moreover, any range of values denoted by the expression “between a and b” represents the field of values greater than “a” and less than “b” (that is to say limits a and b excluded) whereas any range of values denoted by the expression “from a to b” means the field of values ranging from “a” up to “b” (that is to say including the strict limits a and b).

The expression composition “based on” should be understood in the present description to mean a composition comprising the mixture and/or the in situ reaction product of the various constituents used, some of these base constituents (for example the elastomer, the filler or other additives conventionally used in a rubber composition intended for tire manufacture) being capable of reacting, or intended to react, with one another, at least in part, during the various phases of manufacture of the composition intended for tire manufacture.

The direction z is defined as being the direction normal to the surface of the tread intended to be in contact with a running surface, x and y as being two directions orthogonal to z, x the circumferential direction of the tire, y the axial direction with respect to the axis of rotation of the tire. Cx, Cy and Cz are the thermal diffusivities of the tread in the cured state respectively in the directions x, y and z. They are measured at 25° C. according to the standard ASTM E 1641.

The ratios of the thermal diffusivities measured at 25° C., Cz/Cx and Cz/Cy, are greater than 2, preferably greater than 3, more preferably greater than or equal to 4. These ratio values characterize a certain thermal anisotropy of the tread caused by a preferential orientation of the ex-pitch carbon fibres in the direction normal to the surface of the tread.

The elastomer matrix may consist of one or more elastomers that differ from one another due to their macrostructure or their microstructure. The elastomer matrix preferably comprises a diene elastomer.

The term “diene” elastomer (or else rubber) should be understood to mean, in a known manner, one (or more) elastomer(s) consisting at least in part (i.e., a homopolymer or a copolymer) of diene monomer units (monomers bearing two conjugated or non-conjugated carbon-carbon double bonds).

These diene elastomers can be classified into two categories: “essentially unsaturated” or “essentially saturated”. The expression “essentially unsaturated” is generally understood to mean a diene elastomer resulting at least partly from conjugated diene monomers, having a content of units of diene origin (conjugated dienes) that is greater than 15% (mol %). Thus, diene elastomers such as butyl rubbers or diene/α-olefin copolymers of EPDM type do not fall under the preceding definition and may especially be described as “essentially saturated” diene elastomers (low or very low content of units of diene origin, always less than 15%). In the “essentially unsaturated” diene elastomer category, the expression “highly unsaturated” diene elastomer is understood in particular to mean a diene elastomer having a content of units of diene origin (conjugated dienes) that is greater than 50%.

Having given these definitions, it will be understood more particularly that a diene elastomer capable of being used in the compositions in accordance with the disclosure means:

(a)—any homopolymer of a conjugated diene monomer, especially any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidene norbornene or dicyclopentadiene;
(d)—a copolymer of isobutene and of isoprene (butyl rubber) and also the halogenated versions, in particular chlorinated or brominated versions, of this type of copolymer.

Although it applies to any type of diene elastomer, a person skilled in the art of tires will understand that the present disclosure is preferably employed with essentially unsaturated diene elastomers, in particular of the type (a) or (b) above.

In the case of copolymers of type (b), these contain from 20% to 99% by weight of diene units and from 1% to 80% by weight of vinylaromatic units.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene.

The following, for example, are suitable as vinylaromatic compounds: stirene, ortho-, meta- or para-methylstirene, alpha-methylstirene, the “vinyltoluene” commercial mixture, para-(tert-butyl)stirene, methoxystirenes, chlorostirenes, vinylmesitylene, divinylbenzene or vinylnaphthalene.

Preferably, the diene elastomer is an essentially unsaturated elastomer selected from the group consisting of polybutadienes, polyisoprenes, butadiene copolymers, isoprene copolymers and mixtures of these elastomers. The following are very particularly suitable as diene elastomer: a polybutadiene (BR), a copolymer of butadiene and stirene (SBR), a natural rubber (NR) or a synthetic polyisoprene (IR) preferably having a molar content of cis-1,4-bonds of greater than 90%, or mixtures thereof.

As reinforcing filler, use may be made of any type of filler referred to as reinforcing, known for its abilities to reinforce a rubber composition that can be used for the manufacture of tires, for example an organic filler such as carbon black, a reinforcing inorganic filler such as silica with which a coupling agent is, in a known manner, associated, or else a mixture of these two types of filler.

Such a reinforcing filler typically consists of nanoparticles, the mean size (by weight) of which is less than a micrometre, generally less than 500 nm, most often between 20 and 200 nm, in particular and more preferably between 20 and 150 nm.

All carbon blacks are suitable as carbon blacks, especially the blacks conventionally used in tires or their treads (tire-grade blacks). Among the latter, mention will more particularly be made of the reinforcing carbon blacks of the 100, 200 or 300 series or the blacks of the 500, 600 or 700 series (ASTM grades), such as for example the N115, N134, N234, N326, N330, N339, N347, N375, N550, N683 or N772 blacks. These carbon blacks may be used in the isolated state, as available commercially, or in any other form, for example as a support for some of the rubber additives used.

The expression “reinforcing inorganic filler” should be understood here to mean any inorganic or mineral filler, whatever its colour and its origin (natural or synthetic), also referred to as “white filler”, “clear filler” or even “non-black filler” in contrast to carbon black, this inorganic filler being capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known manner, by the presence of hydroxyl (OH) groups at its surface.

Mineral fillers of the siliceous type, preferably silica (SiO₂), are suitable in particular as reinforcing inorganic fillers. The silica used may be any reinforcing silica known to a person skilled in the art, especially any precipitated or fumed silica having a BET surface area and also a CTAB specific surface area that are both less than 450 m²/g, preferably from 30 to 400 m²/g, in particular between 60 and 300 m²/g. As highly dispersible precipitated silicas (“HDSs”), mention will be made, for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in application WO 03/016387.

In the present account, the BET specific surface area is determined in a known manner by gas adsorption using the Brunauer-Emmett-Teller method described in “The Journal of the American Chemical Society” Vol. 60, page 309, February 1938, more specifically according to French standard NF ISO 9277 of December 1996 (multipoint (5 points) volumetric method—gas: nitrogen—degassing: 1 hour at 160° C.—relative pressure p/po range: 0.05 to 0.17). The CTAB specific surface area is the outer surface area determined according to the French standard NF T 45-007 of November 1987 (method B).

The physical state in which the reinforcing inorganic filler is provided is not important, whether it is in the form of a powder, of micropearls, of granules or else of beads. Of course, the expression “reinforcing inorganic filler” is also understood to mean mixtures of various reinforcing inorganic fillers, in particular of highly dispersible silicas as described above.

A person skilled in the art will understand that a reinforcing filler of another nature, in particular an organic filler, such as carbon black, could be used as filler equivalent to the reinforcing inorganic filler described in the present section, provided that this reinforcing filler is covered with an inorganic layer, such as silica, or else comprises, at its surface, functional sites, in particular hydroxyl sites, requiring the use of a coupling agent in order to establish the bond between the filler and the elastomer. By way of example, mention may be made, for example, of tire-grade carbon blacks as described for example in patent documents WO 96/37547 and WO 99/28380.

The reinforcing filler may comprise a carbon black, an inorganic filler or a mixture thereof, the inorganic filler preferably being a silica.

According to one particular embodiment of the disclosure, the inorganic filler, preferably a silica, represents more than 50% by weight of the reinforcing filler of the rubber composition. It is then said that the reinforcing inorganic filler is predominant.

When it is combined with a predominant reinforcing inorganic filler such as silica, the carbon black is preferably used at a content of less than 20 phr, more preferably less than 10 phr (for example between 0.5 and 20 phr, especially between 2 and 10 phr). In the ranges indicated, the colouring properties (black pigmenting agent) and UV-stabilizing properties of the carbon blacks are benefited from, without, moreover, adversely affecting the typical performances provided by the reinforcing inorganic filler.

A person skilled in the art knows how to adjust the content of total reinforcing filler in the rubber composition as a function of the targeted application of the rubber composition and as a function of the amount of plasticizer in the rubber composition in order to be able to achieve the processability of the rubber composition. Consequently, for a plasticizer content range, a person skilled in the art adapts the content of reinforcing filler.

The content of total reinforcing filler is preferably between 30 and 180 phr, more preferably between 40 phr and 160 phr. Below 30 phr, the reinforcement of the rubber composition may be insufficient to provide an adequate level of cohesion or of wear resistance of the rubbery component of the tire comprising this composition. Beyond 180 phr, there is a risk of increasing the hysteresis and therefore the rolling resistance of the tires. More preferably still, the content of total reinforcing filler is at least 50 phr and at most 160 phr. Advantageously, the content of total reinforcing filler varies within a range extending from 80 phr to 140 phr, in particular in a composition intended for a tread for passenger vehicle tires. Any one of these ranges of content of total reinforcing filler applies to any one of the embodiments of the disclosure.

In order to couple the reinforcing inorganic filler to the diene elastomer, use is made, in a known manner, of an at least bifunctional coupling agent (or bonding agent) intended to provide a sufficient connection, of chemical and/or physical nature, between the inorganic filler (surface of its particles) and the diene elastomer. In particular, use is made of at least bifunctional organosilanes or polyorganosiloxanes.

Use is made, in particular, of silane polysulphides, referred to as “symmetrical” or “asymmetrical” depending on their particular structure, as described for example in applications WO 03/002648 (or US 2005/016651) and WO 03/002649 (or US 2005/016650).

Suitable in particular, without the definition below being limiting, are silane polysulphides corresponding to the general formula (V)

Z-A-Sₓ-A-Z (V)
in which:
   x is an integer from 2 to 8 (preferably from 2 to 5);
   the A symbols, which are identical or different, represent a divalent hydrocarbon radical (preferably a C₁-C₁₈ alkylene group or a C₆-C₁₂ arylene group, more particularly a C₁-C₁₀, especially C₁-C₄, alkylene, in particular propylene);
   the Z symbols, which are identical or different, correspond to one of the three formulae below:

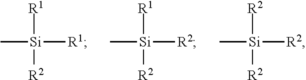

in which:
   the R¹ radicals, which are substituted or unsubstituted, identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, especially C₁-C₄ alkyl groups, more particularly methyl and/or ethyl);
   the R² radicals, which are substituted or unsubstituted, identical to or different from one another, represent a C₁-C₁₈ alkoxy or C₅-C₁₈ cycloalkoxy group (preferably a group selected from C₁-C₈ alkoxys and C₅-C₈ cycloalkoxys, more preferably still a group selected from C₁-C₄ alkoxys, in particular methoxy and ethoxy).

In the case of a mixture of alkoxysilane polysulphides corresponding to the formula (I) above, especially standard commercially available mixtures, the mean value of the “x” indices is a fractional number preferably of between 2 and 5, more preferably of approximately 4. But the disclosure may also advantageously be carried out for example with alkoxysilane disulphides (x=2).

Mention will more particularly be made, as examples of silane polysulphides, of bis((C₁-C₄)alkoxy(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂.

Mention will in particular be made, as coupling agent other than alkoxysilane polysulphide, of bifunctional POSs (polyorganosiloxanes), or else of hydroxysilane polysulphides as described in patent applications WO 02/30939 (or U.S. Pat. No. 6,774,255), WO 02/31041 (or US 2004/051210), or else of silanes or POSs bearing azodicarbonyl functional groups, such as described, for example, in patent applications WO 2006/125532, WO 2006/125533 and WO 2006/125534.

The content of coupling agent is advantageously less than 20 phr, it being understood that it is in general desirable to use as little as possible thereof. Typically, the content of coupling agent represents from 0.5% to 15% by weight relative to the amount of inorganic filler. Its content is preferably between 0.5 and 15 phr, more preferably within a range of from 3 to 13 phr. This content is easily adjusted by a person skilled in the art depending on the content of inorganic filler used in the composition.

According to one embodiment of the disclosure, the rubber composition comprises a plasticizer. A plasticizer is understood to mean one or more plasticizers. The plasticizer may be a liquid plasticizer, a resin or a mixture thereof.

The term “resin” is reserved in the present application, by definition known to a person skilled in the art, for a compound which is solid at ambient temperature (23° C.), as opposed to a liquid plasticizing compound such as an oil.

Hydrocarbon resins are polymers well known to a person skilled in the art, essentially based on carbon and hydrogen but that may comprise other types of atoms, that can be used in particular as plasticizing agents or tackifying agents in polymer matrices. They are by nature miscible (i.e. compatible) at the contents used with the polymer compositions for which they are intended, so as to act as true diluents. They have been described, for example, in the book entitled “Hydrocarbon Resins” by R. Mildenberg, M. Zander and G. Collin (New York, V C H, 1997, ISBN 3-527-28617-9), Chapter 5 of which is devoted to their applications, especially in the tire rubber field (5.5. “Rubber Tires and Mechanical Goods”). They may be aliphatic, cycloaliphatic, aromatic, hydrogenated aromatic, of aliphatic/aromatic type, i.e. based on aliphatic and/or aromatic monomers. They may be natural or synthetic, and may or may not be based on petroleum (if such is the case, they are also known under the name of petroleum resins). Their Tg is preferably greater than 0° C., in particular greater than 20° C. (most often between 30° C. and 95° C.).

In a known manner, these hydrocarbon resins may also be described as thermoplastic resins in the sense that they soften upon heating and may thus be molded. They may also be defined by a softening point. The softening point of hydrocarbon resin is generally approximately 40 to 60° C. above its Tg value. The softening point is measured according to the standard ISO 4625 (“Ring and Ball” method). The macrostructure (Mw, Mn and PDI) is determined by size exclusion chromatography (SEC) as indicated below.

As a reminder, the SEC analysis, for example, consists in separating the macromolecules in solution according to their size through columns filled with a porous gel; the molecules are separated according to their hydrodynamic volume, the bulkiest being eluted first. The sample to be analysed is simply dissolved beforehand in an appropriate solvent, tetrahydrofuran at a concentration of 1 g/litre. The solution is then filtered through a filter with a porosity of 0.45 μm, before injection into the apparatus. The apparatus used is for example a “Waters alliance” chromatographic line, according to the following conditions:
elution solvent: tetrahydrofuran,
temperature 35° C.;
concentration 1 g/litre;
flow rate: 1 ml/min;
volume injected: 100 μl;
Moore calibration with polystirene standards;
set of 3 “Waters” columns in series (“Styragel HR4E”, “Styragel HR1” and “Styragel HR 0.5”);
detection by differential refractometer (for example “WATERS 2410”) that may be equipped with operating software (for example “Waters Millenium”).

A Moore calibration is carried out with a series of commercial polystirene standards having a low PDI (less than 1.2), known molar masses, covering the range of masses to be analysed. The weight-average molar mass (Mw), the number-average molar mass (Mn) and also the polydispersity index (PDI=Mw/Mn) are deduced from the data recorded (curve of distribution by mass of the molar masses).

All the values of molar masses indicated in the present application are therefore relative to calibration curves produced with polystirene standards.

According to one preferred embodiment of the disclosure, the hydrocarbon resin has at least any one, more preferably all, of the following features:
a Tg above 25° C. (in particular between 30° C. and 100° C.), more preferably above 30° C. (in particular between 30° C. and 95° C.);
a softening point above 50° C. (in particular between 50° C. and 150° C.); a number-average molar mass (Mn) of between 400 and 2000 g/mol, preferably between 500 and 1500 g/mol;
a polydispersity index (PDI) of less than 3, preferably less than 2 (reminder: PDI=Mw/Mn with Mw being the weight-average molar mass).

As examples of such hydrocarbon resins, mention may be made of those selected from the group consisting of cyclopentadiene (abbreviated to CPD) homopolymer or copolymer resins, dicyclopentadiene (abbreviated to DCPD) homopolymer or copolymer resins, terpene homopolymer or copolymer resins, C₅ fraction homopolymer or copolymer resins, C₉ fraction homopolymer or copolymer resins, α-methylstirene homopolymer or copolymer resins and the mixtures of these resins. Mention may more particularly be made, among the above copolymer resins, of those selected from the group consisting of (D)CPD/vinylaromatic copolymer resins, (D)CPD/terpene copolymer resins, terpene/phenol copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins, and the mixtures of these resins.

The term “terpene” combines here, in a known manner, α-pinene, β-pinene and limonene monomers; use is preferably made of a limonene monomer, which compound exists, in a known manner, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomers are, for example: stirene, α-methylstirene, ortho-, meta- or para-methylstirene, vinyltoluene, para-(tert-butyl)stirene, methoxystirenes, chlorostirenes, hydroxystirenes, vinylmesitylene, divinylbenzene, vinylnaphthalene or any vinylaromatic monomer resulting from a C₉ fraction (or more generally from a C₈ to C₁₀ fraction).

More particularly, mention may be made of the resins selected from the group consisting of (D)CPD homopolymer resins, (D)CPD/stirene copolymer resins, polylimonene resins, limonene/stirene copolymer resins, limonene/D(CPD) copolymer resins, C₅ fraction/stirene copolymer resins, C₅ fraction/C₉ fraction copolymer resins, and the mixtures of these resins.

All the above resins are well known to a person skilled in the art and are available commercially, for example sold by the company DRT under the name “Dercolyte” as regards the polylimonene resins, by the company Neville Chemical Company under the name “Super Nevtac”, by Kolon under the name “Hikorez” or by Exxon Mobil under the name “Escorez” as regards the C₅ fraction/stirene resins or C₅ fraction/C₉ fraction resins, or else by Struktol under the name “40 MS” or “40 NS” (mixtures of aromatic and/or aliphatic resins).

Any liquid plasticizing agent, in particular an oil, known for its plasticizing properties with respect to diene elastomers, can be used. At ambient temperature (23° C.), these plasticizers or these oils, which are more or less viscous, are liquids (that is to say, as a reminder, substances that have the ability to eventually take on the shape of their container), as opposed, in particular, to plasticizing hydrocarbon resins which are by nature solids at ambient temperature.

The liquid plasticizing agents selected from the group consisting of liquid diene polymers, polyolefinic oils, naphthenic oils, paraffinic oils, DAE oils, MES (Medium Extracted Solvate) oils, TDAE (Treated Distillate Aromatic Extract) oils, RAE (Residual Aromatic Extract) oils, TRAE (Treated Residual Aromatic Extract) oils and SRAE (Safety Residual Aromatic Extract) oils, mineral oils, vegetable oils, ether plasticizers, ester plasticizers, phosphate plasticizers, sulphonate plasticizers and the mixtures of these compounds are particularly suitable. According to a more preferred embodiment, the liquid plasticizing agent is selected from the group consisting of MES oils, TDAE oils, naphthenic oils, vegetable oils and the mixtures of these oils.

The content of plasticizer, namely of liquid plasticizer or of resin or of their mixture, in the rubber composition may vary widely depending on the amount of reinforcing filler and of ex-pitch carbon fibres introduced into the rubber composition, but also for example as a function of the viscosity of the elastomer matrix and depending on the desired levels of stiffness of the rubber composition in the uncured and cured states. The amount of plasticizer is determined according to a chosen dilution ratio. The dilution ratio is understood to mean the ratio of the weight of the plasticizer to the sum of the weights of the plasticizer and of the elastomer matrix.

According to one embodiment of the disclosure, the amount of plasticizer in the rubber composition is adjusted so as to achieve a dilution ratio of greater than 0.35. The dilution ratio is preferably between 0.35 and 0.60, more preferably between 0.35 and 0.55. Due to the anisotropy of the tread of the tire caused by a preferential orientation of the ex-pitch carbon fibres in the direction normal to the surface of the tread, the tread of the tire in accordance with the disclosure has different stiffnesses in the directions x, y, z. The dilution ratio makes it possible to adjust these stiffnesses in order to achieve a compromise between these stiffnesses. The optimization of this compromise makes it possible in turn to optimize the operation of the tire.

The ex-pitch carbon fibres are derived from pitch, for example coal or petroleum pitches and may be prepared according to the following process: the pitches are, in a first step, converted into fibrillar precursors by a first step of melt spinning, these fibrillar precursors are then generally heat stabilized by a first heat treatment under an oxidizing atmosphere (100° C.-400° C.) before undergoing treatments at higher temperatures under an inert carbonization atmosphere (1000-1600° C.) then graphitization atmosphere (2500° C.-3000° C.). The process of manufacturing ex-pitch carbon fibres is widely described, for example in the journal “Nippon Steel Technical Report, No. 59, October 1993, page 65” or in the reference book “Carbon Fibers”; 1998; 3rd edition; Donnet, J.-B., Wang, T. K., Rebouillat, S., Peng, J. C. M.

The ex-pitch carbon fibres are objects characterized generally by a fibre diameter that is at least one micron. Their diameter may vary from 1 μm to 50 μm, preferably from 3 μm to 20 μm, more preferably from 5 μm to 15 μm. These preferential diameter ranges of the ex-pitch carbon fibres apply to any one of the embodiments of the disclosure.

The ex-pitch carbon fibres may have a length which varies widely. The choice of the length of the lengths of the ex-pitch carbon fibres is generally limited to the products offered by the suppliers. A person skilled in the art also understands that the length of the ex-pitch carbon fibres is limited by the dimensions of the compounding equipment used for mixing the various ingredients of the rubber composition, since they must be able to be introduced into the compounding tools. For example, irrespective of the embodiment of the disclosure, the ex-pitch carbon fibres having a number-average length ranging from a hundred microns to several millimetres, for example from 50 μm to 30 mm or from 50 μm to 3 mm, are suitable. Use is made of carbon fibres having a length that varies preferably from 50 μm to 500 μm, more preferably from 50 μm to 250 μm. These preferential length ranges of the ex-pitch carbon fibres apply to any one of the embodiments of the disclosure. Use is typically made of chopped fibres or milled fibres.

The average length of the ex-pitch carbon fibres is determined according to the method described in section II.1.3, more specifically starting from the second operation described in subsection ii).

During the compounding of the ex-pitch carbon fibres with the other ingredients of the rubber composition, mechanical action may chop the ex-pitch carbon fibres into a length smaller than their original length, that is to say the length that they had before compounding. The number-average length of the ex-pitch carbon fibres in the rubber composition may range from 50 μm to 250 μm.

According to one embodiment of the disclosure that is applicable to the embodiments described, the volume fraction of the ex-pitch carbon fibres in the rubber composition varies within a range extending from 1 to 15%. Preferably, this volume fraction varies within a range extending from 3 to 12%. The volume fraction of the ex-pitch carbon fibres is defined as being the ratio of the volume of the ex-pitch carbon fibres to the volume of all of the constituents of the rubber composition, it being understood that the volume of all of the constituents is calculated by adding up the volume of each of the constituents of the rubber composition. Below 1%, it is observed that the rubber composition is not conductive enough to make it possible to significantly reduce the curing time of the tire. Beyond 15%, the wear performance of the tire may be adversely affected and also the grip performance of the tire due to an excessively high stiffness of the rubber composition that makes up the tread. The preferential range of from 3 to 12% makes it possible to further optimize the compromise between thermal conductivity and wear of the tread.

The amount of ex-pitch carbon fibres in the rubber composition is determined by its volume fraction and therefore depends on the amount of the other components of the rubber composition, especially on the amount of plasticizer in the rubber composition. Since the amount of plasticizer makes it possible to adjust the stiffness of the rubber composition and its processability, the amount of ex-pitch carbon fibres is adjusted according to the targeted volume fraction of ex-pitch carbon fibres in the rubber composition and according to the targeted stiffness and viscosity of the rubber composition. For a dilution ratio ranging from 0.35 to 0.60, the amount of carbon fibres may vary from 4 to 160 phr depending on the targeted volume fraction of ex-pitch carbon fibres in the rubber composition, especially for volume fractions ranging from 1 to 15%. For example, for a dilution ratio of 0.35, the amount of ex-pitch carbon fibres in the rubber composition may vary from 4 to 100 phr. For example, for a dilution ratio of 0.60, the amount of ex-pitch carbon fibres in the rubber composition may vary from 7 to 160 phr.

The rubber composition in accordance with the disclosure may also comprise all or some of the usual additives customarily used in the elastomer compositions intended to form external compounds of finished rubber objects such as tires, in particular treads, pigments, protective agents such as anti-ozone waxes, chemical antiozonants, antioxidants, antifatigue agents, a crosslinking system, vulcanization accelerators or retarders, or vulcanization activators. Irrespective of the embodiment of the disclosure described, the crosslinking system is preferably based on sulphur, but it may also be based on sulphur donors, peroxides, bismaleimides or mixtures thereof.

The compounding of the constituents of the rubber composition may be carried out in a conventional manner in appropriate mixers, using two successive preparation phases well known to a person skilled in the art: a first phase of thermomechanical working or kneading (“non-productive” phase) at high temperature, up to a maximum temperature between 130° C. and 200° C., followed by a second phase of mechanical working (“productive” phase) up to a lower temperature, typically below 110° C., for example between 40° C. and 100° C., during which finishing phase the crosslinking system is incorporated.

The tread of the tire in accordance with the disclosure may be prepared according to a process which comprises the following steps:
mixing the elastomer matrix, the reinforcing filler, the ex-pitch carbon fibres, and where appropriate the plasticizer, in order to form a compound,
calendering the compound in order to form a layer having a midplane (y′z′) defined by two directions y′ and z′ orthogonal to one another, z′ being the calendering direction, so as to orientate the ex-pitch carbon fibres in the calendering direction,
then cutting the layer into identical portions along a cutting plane perpendicular to the direction z′,
assembling the portions by juxtaposing them in pairs along their respective faces perpendicular to the direction x′ orthogonal to the midplane (y′z′).

A layer is understood to mean a more or less uniform area of the composition, the thickness of which is small relative to the surface area. Generally, a layer has a midplane (y′z′) defined by two orthogonal directions y′ and z′. The direction x′ is defined as being the direction orthogonal to the midplane (y′z′).

During the assembly of a tire that usually comprises, radially from the outside inwards, a tread, a crown reinforcement and a carcass reinforcement, the tread may be laid radially on the outside of the crown reinforcement of the tire so that the ex-pitch carbon fibres are preferably orientated radially with respect to the axis of rotation of the tire.

As a function of the particular conditions for implementation of the disclosure, the thickness of the layer is adjusted during the calendering step so as to obtain the orientation of the ex-pitch carbon fibres in the calendering direction. The orientation of the ex-pitch carbon fibres in the layer may be carried out typically after homogenization of the vulcanization system by passing the compound into a calender several times, always in the same direction.

Alternatively, the tread of the tire in accordance with the disclosure may be prepared according to the process described above by replacing the cutting and assembling step with a zigzag folding of the layer, as is described for example in U.S. Pat. No. 6,666,247.

According to one preferred embodiment of the disclosure, the tread of the tire in accordance with the disclosure consists only of the rubber composition described according to any one of the embodiments of the disclosure.

The layer, which is another subject of the disclosure, has the essential feature of consisting of the same rubber composition as the tread of the tire in accordance with the disclosure. The layer in accordance with the disclosure also has the essential feature of having C′z′/C′x′ and C′z′/C′y′ thermal diffusivity ratios of greater than 2,
C′x, C′y′ and C′z′ being the thermal diffusivities measured at 25° C. of the layer in the cured state respectively in the directions x′, y′ and z′,
x′, y′ and z′ being directions orthogonal to one another, z′ being the preferential direction of the carbon fibres.

Irrespective of the embodiment of the layer in accordance with the disclosure, the C′z′/C′x′ and C′z′/C′y′ thermal diffusivity ratios, also measured at 25° C., are preferably greater than 3, more preferably greater than or equal to 4. These preferential ratios apply to the layer consisting of a composition defined according to any one of the embodiments of the disclosure.

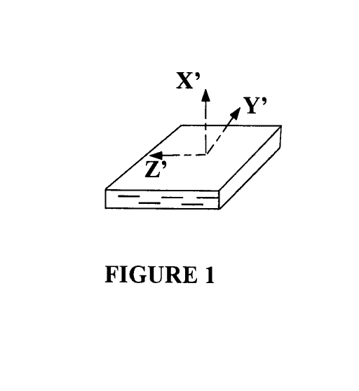

According to one particular embodiment of the disclosure, y′ and z′ define the midplane of the layer, x′ is the direction orthogonal to the midplane (y′z′). This embodiment is illustrated by FIG. 1.

According to this particular embodiment, the layer in accordance with the disclosure is used as an element of a tread of a tire. In this case, the tread or a portion of tread is formed by the juxtaposition of layers in accordance with the disclosure assembled along their faces perpendicular to the direction x′, x′ being the direction orthogonal to the midplane of each layer (y′z′) defined by the directions y′ and z′, the direction z′ coinciding with the radial direction of the tire. According to this particular embodiment of the disclosure, x′ preferably coincides with the circumferential direction of the tire.

The layer may be prepared by a process which comprises the following steps:
mixing the elastomer matrix, the reinforcing filler, the ex-pitch carbon fibres, and where appropriate the plasticizer, in order to form a compound,
calendering the compound in order to form a layer so as to orientate the ex-pitch carbon fibres in the calendering direction, z′ coinciding with the calendering direction.

The aforementioned features of the present disclosure, and also other features, will be better understood on reading the following description of several exemplary embodiments of the disclosure, given by way of non-limiting illustration.

### II.1—Measurements and Tests Used:

### II.1.1 Wear Test:

The wear resistance of each tire was determined by means of a relative wear index which is a function of the height of rubber remaining, after running on a harsh circuit for wear with lots of bends and the surfacing of which is characterized by micro-roughnesses, at an average speed of 77 km/h and until the wear reaches the wear controls positioned in the grooves of the treads. For each of the examples, this relative wear index was obtained by comparing the height of rubber remaining for the tread studied to the height of rubber remaining for the control tread, which has, by definition, a wear index of 100.

### II.1.2 Thermal Diffusivity:

The thermal diffusivity is determined according to the standard ASTM E 1641 at 25° C. The thermal diffusivity of the layer CA or CB is expressed relative to a base 100 with respect to the layer CT taken as a control. The higher the value is above 100, the greater the conductivity of the slab in the direction considered.

The thermal anisotropy of the layer is expressed by the ratio C′z′/C′x′ and C′z′/C′y′, knowing that the direction z′ is the direction normal to a surface of the layer and corresponds to the calendering direction.

### II.1.3 Microscopy Analysis:

The number-average length of the carbon fibres in the rubber composition is determined according to the method described below.

The dimensions are measured according to the procedure described below in several steps. The object formed by the rubber composition after compounding the constituents of the rubber composition and after vulcanization is referred to as a compound.

II.1.3.i) The first step consists in extracting the carbon fibres from the compound by proceeding in the following manner:
the compound is cut into small pieces then an acetone extraction is carried out so as to eliminate as much as possible the additives such as oils, resins, waxes, antioxidants, etc.,
the compound is then pyrolysed under an inert atmosphere (N₂) at 550° C., so as to eliminate the organic substances by cracking: polymers, sulphur network, accelerators, residual plasticizers, etc.,
the residue obtained then contains the carbon fibres, the carbon black and mineral products initially present in the compound (such as silica) or optionally formed during the pyrolysis.
   II.1.3.ii) The second step consists in preparing the sample to be placed in the scanning electron microscope (SEM) by proceeding in the following manner:
At the end of the first step, the combustion residues containing the carbon fibres are recovered. These residues are very slightly compressed using a mortar and pestle in order to separate the fibres from one another.
The carbon fibres are thus recovered on a sample holder comprising a carbon adhesive tape. It is also possible to directly stamp the aluminium sample holder bearing the carbon adhesive tape onto the extracted fibres.
The samples are then blown with dry air in order to eliminate the free fibres that could damage the column of the microscope.
   II.1.3.iii) The third step consists in determining the dimensions of the carbon fibres:
The samples are observed by scanning electron microscopy (FEG-SEM) on an FEI Quanta 400 microscope in low vacuum mode. The observations are made in topographic contrast. Field widths of 1 mm, or even 2 mm, 500 μm and 250 μm are mainly worked with in order to scan the entire size range.
Once the observations have been made, length measurements are carried out by means of AnalySIS image processing software. A bitmap observation of the samples is carried out: adjacent fields were created in order to cover around 5 mm² on the sample holder, with observation fields of 500 μm. The bitmap image was reconstructed with the aid of the AnalySIS image processing software. All of the results are compiled in order to obtain data characteristic of the fibre extracted from the compound (average length, minimum length, maximum length, standard deviation, number distribution). For each sample, at least 50 objects are measured.

### II.2—Preparation of the Rubber Compositions:

The formulations (in phr) of the compositions T, A and B are described in Table I.

The compositions A and B both contain carbon fibres in a volume fraction of 10%. They differ in that the composition A contains ex-PAN (polyacrylonitrile) carbon fibres and the composition B contains ex-pitch carbon fibres.

The composition T differs from the compositions A and B in that it contains no carbon fibres.

The dilution ratio of the compositions A, B and T is identical (0.4).

The compositions are prepared by thermal kneading of the constituents of the composition according to the following procedure:

These compositions are manufactured in the following manner: the elastomer, the reinforcing filler, the coupling agent, the plasticizers, the carbon fibres and also the various other ingredients, with the exception of the vulcanization system, are introduced into an internal mixer (final fill ratio: around 70% by volume), the initial vessel temperature of which is around 80° C. Thermomechanical working (non-productive phase) is then carried out in one step, which lasts around 5 to 6 minutes, until a maximum “dropping” temperature of around 160° C. is reached. The compound thus obtained is recovered and cooled and then sulphur and the sulphenamide accelerator are incorporated on a mixer (homofinisher) at 23° C., by mixing everything (productive phase) for an appropriate time (for example between 5 and 12 min). This operation of homogenization of the vulcanization system (sulphur and sulphenamide) consists in passing the compound between the rolls twelve times, each time changing the direction of introduction (the compound is recovered under the rolls, it is folded and reintroduced between the rolls by changing the direction of passage).

In the case of the compositions A and B, after homogenization of the vulcanization system, twelve additional passes are carried out without changing the direction of introduction of the compound, for the purpose of orientating the carbon fibres (within the sheet of compound) in the calendering direction.

Next, the layers CT, CA and CB consisting respectively of the compositions T, A and B are cut in the form of test specimens and then vulcanized. In the case of the preparation of test specimens from the layers CA and CB, the sizing of a layer to the size of a 2.5 mm thick test specimen is carried out by gradual reduction of the thickness of the layer by passing the compound through a calender while retaining the direction imposed during the orientation of the carbon fibres on the homofinisher.

The vulcanized layers are characterized in order to determine:
their thermal diffusivities respectively in the direction normal to the surface of the layer z′, along x′ and y′ directions that are orthogonal to one another and to z′
and also their thermal anisotropy.

The compositions A, B and T are used respectively as layers CA. CB and CT in order to form treads of a tire. The layers are laid radially on the outside of the crown reinforcement of the tire so that the carbon fibres are preferably orientated in the radial direction with respect to the axis of rotation of the tire. The treads are produced according to the process described above which uses cutting and assembling steps.

### II.3—Results

The results appear in Table II and Table III.

The number-average length of the carbon fibres in the rubber composition is 172 μm and 100 μm respectively for the layers CA and CB.

### Thermal Diffusivity and Anisotropy:

The C′z′/C′x′ and C′z′/C′y′ ratios of the layers CA and CB demonstrate their thermal anisotropy and also the preferential orientation of the carbon fibres in the calendering direction. Since the values of C′z′/C′x′ and C′z′/C′y′ are equal to 1 for the layer CT, it is clearly verified that the layer CT is isotropic.

The layer CB constitutes the material that has both the best thermal diffusivity and the highest thermal anisotropy compared to the layer CA.

### Wear:

By using the layer CA, tearing off of very large block-shaped pieces of material was very rapidly observed, the wear test becoming unquantifiable. This very rapid and very substantial deterioration demonstrates that the layer CA used as tread of a tire has almost no wear resistance. On the other hand, the tread comprising the layer CB in accordance with the disclosure has a certain wear resistance (index of 80), admittedly slightly reduced relative to the tread comprising the layer CT.

It is observed that the tire in accordance with the disclosure offers a better thermal conductivity/wear compromise than the tire not in accordance with the disclosure comprising the ex-PAN carbon fibres. Furthermore, the tire in accordance with the disclosure has an improved thermal conductivity/wear compromise compared to the control tire comprising no carbon fibres. The improvement in this compromise also makes it possible to improve the compromise between the productivity of the curing step in the production of the tire and the wear performance of the tire.

TABLE I

| Composition | T | A | B |
|---|---|---|---|
| SBR (1) | 100 | 100 | 100 |
| Carbon black (2) | 4 | 4 | 4 |
| Silica (3) | 109 | 109 | 109 |
| Ex-PAN carbon fibres (4) | | 49 | |
| Ex-pitch carbon fibres (5) | | | 61 |
| Coupling agent (6) | 8 | 8 | 8 |
| DPG (7) | 1.7 | 1.7 | 1.7 |
| Oil (8) | 14 | 14 | 14 |
| Resin (9) | 54 | 54 | 54 |
| 6PPD (10) | 2.3 | 2.3 | 2.3 |
| Stearic acid (11) | 2 | 2 | 2 |
| ZnO (12) | 2.5 | 2.5 | 2.5 |
| CBS (13) | 1.8 | 1.8 | 1.8 |
| Sulphur | 1.4 | 1.4 | 1.4 |
| Volume fraction of the | 0 | 10% | 10% |
| carbon fibres (%) | | | |

(1) SBR solution containing 26% stirene and 24% 1,2-butadiene units of the butadiene part having an —SiOH function at the chain end;
(2) Carbon black of N234 type;
(3) “Zeosil 1165 MP” silica;
(4) “SIGRAFIL C 30 APS” ex-PAN carbon fibres from SGL Group;
(5) “XN-100” ex-pitch carbon fibres from Nippon Graphite Fiber Corporation;
(6) “Si69” bis(triethoxysilylpropyl)tetrasulphide from Evonik;
(7) “Perkacit DPG” diphenylguanidine from Flexsys;
(8) Oleic sunflower oil (Lubrirob TOD 1880 from Novance);
(9) “Wingtack STS” C5/C9 resin from Cray Valley;
(10) “Santoflex 6PPD” N-1,3-dimethylbutyl-N-phenyl-para-phenylenediamine from Eastman;
(11) Stearic acid;
(12) Zinc oxide (industrial grade - Umicore);
(13) N-cyclohexyl-2-benzothiazole sulphenamide (“Santocure CBS” from Flexsys).

TABLE II

| Layer | CT | CA | CB |
|---|---|---|---|
| C′z′/C′x′ | 1 | 2.7 | 5.2 |
| C′z′/C′y′ | 1 | 2.7 | 5.2 |
| C′z′ | 100 | 342 | 770 |

TABLE III

| Layer | CT | CA | CB |
|---|---|---|---|
| Wear | 100 | Unquantifiable | 80 |

1. A tire having a tread that include a rubber composition, comprising:
an elastomer matrix,
a reinforcing filler,
ex-pitch carbon fibres,
optionally a plasticizer,
z being the direction normal to the surface of the tread intended to be in contact with a running surface, x and y being two directions orthogonal to z, x the circumferential direction of the tire, y the axial direction with respect to the axis of rotation of the tire,
Cx, Cy and Cz being the thermal diffusivities measured at 25° C. of the tread in the cured state respectively in the directions x, y and z,
which wherein the Cz/Cx and Cz/Cy thermal diffusivity ratios are greater than 2.

2. A tire according to claim 1, wherein the elastomer matrix comprises a diene elastomer.

3. A tire according to claim 1, wherein the rubber composition comprises a plasticizer.

4. A tire according to claim 3, wherein the ratio of the weight of plasticizer to the sum of the weights of the plasticizer and of the elastomer matrix is greater than 0.35.

5. A tire according to claim 4, wherein the ratio of the weight of plasticizer to the sum of the weights of the plasticizer and of the elastomer matrix is between 0.35 and 0.60, preferably between 0.35 and 0.55.

6. A tire according to claim 1, wherein the volume fraction of the ex-pitch carbon fibres in the rubber composition varies within a range extending from 1 to 15%.

7. A tire according to claim 6, wherein the volume fraction of the ex-pitch carbon fibres in the rubber composition varies within a range extending from 3 to 12%.

8. A tire according to claim 1, wherein the reinforcing filler comprises a carbon black.

9. A tire according to claim 1, wherein the reinforcing filler comprises an inorganic filler.

10. A tire according to claim 9, wherein the inorganic filler is a silica.

11. A tire according to claim 9, wherein the inorganic filler represents more than 50% by weight of the reinforcing filler.

12. A tire according to claim 9, wherein the composition comprises a coupling agent.

13. A tire according to claim 11, wherein the content of carbon black is less than 20 phr, preferably less than 10 phr, more preferably between 2 and 10 phr.

14. A tire according to claim 2, wherein the diene elastomer is essentially unsaturated, selected from the group consisting of polybutadienes, polyisoprenes, butadiene copolymers, isoprene copolymers and mixtures thereof.

15. A tire according to claim 14, wherein the diene elastomer is an SBR, a polybutadiene, a synthetic polyisoprene, a natural rubber or mixtures thereof.

16. A tire according to claim 1, wherein the Cz/Cx and Cz/Cy thermal diffusivity ratios are greater than 3.

17. A tire according to claim 16, wherein the Cz/Cx and Cz/Cy thermal diffusivity ratios are greater than or equal to 4.

18. A method for preparing a tire, comprising:
mixing the elastomer matrix, er at the reinforcing filler, the ex-pitch carbon fibres, and where appropriate the plasticizer, in order to form a compound,
calendering the compound in order to form a layer having a midplane (y′z′) defined by two directions y′ and z′ orthogonal to one another, z′ being the calendering direction, so as to orientate the ex-pitch carbon fibres in the calendering direction,
then cutting the layer into identical portions along a cutting plane perpendicular to the direction z′,
assembling the portions by juxtaposing them in pairs along their respective faces perpendicular to the direction x′ orthogonal to the midplane (y′z′).

19. A method for preparing a tire, comprising:
mixing the elastomer matrix, the reinforcing filler, the ex-pitch carbon fibres, and where appropriate the plasticizer, in order to form a compound,
calendering the compound in order to form a layer having a midplane (y′z′) defined by two directions y′ and z′ orthogonal to one another, z′ being the calendering direction, so as to orientate the ex-pitch carbon fibres in the calendering direction,
zigzag folding of the layer.

20. The tire according to claim 1, further comprising a layer consisting of a rubber composition as defined according to any one of claims 1 to 17, which layer has C′z′/C′x′ and C′z′/Cy′ thermal diffusivity ratios of greater than 2,
C′x, C′y′ and C′z′ being the thermal diffusivities measured at 25° C. of the layer in the cured state respectively in the directions x′, y′ and z′,
x′, y′ and z′ being directions orthogonal to one another, z′ being the preferential direction of the carbon fibres.

21. The tire according to claim 20, wherein y′ and z′ define the midplane of the layer, x′ is the direction orthogonal to the midplane (y′z′).

22. The tire according to claim 21, wherein a tread is formed by the juxtaposition of the layer with duplicates of itself, and are assembled along their faces perpendicular to the direction x′, the direction z′ coinciding with the radial direction of the tire.

23. The tire according to claim 22, wherein x′ coincides with the circumferential direction of the tire.

24. Process for preparing a layer according to claim 21, which comprises the following steps:
mixing the elastomer matrix, the reinforcing filler, the ex-pitch carbon fibres, and where appropriate the plasticizer, in order to form a compound,
calendering the compound in order to form a layer so as to orientate the ex-pitch carbon fibres in the calendering direction, z′ coinciding with the calendering direction.
